(19) United States
(12) Patent Application Publication
(10) Pub. No.: US 2005/0156564 A1
(43) Pub. Date: Jul. 21, 2005

(54) Tool box power center

(76) Inventor: Michael Krieger, Miami Beach, FL (US)

Correspondence Address: VECTOR PRODUCTS, INC.;ROBERT POWELL, P.O. BOX 34385, c/o VENABLE LLP, WASHINGTON, DC, 20043-9998, US

(21) Appl. No.: 10/873,626

(22) Filed: Jun. 23, 2004

Related U.S. Application Data
(60) Provisional application No. 60/480,227, filed on Jun. 23, 2003.

(51) Int. Cl. H02J 7/00

(52) U.S. Cl. 320/112

(57) ABSTRACT

A “tool box” style power center is provided. The power center may be designed as a versatile, portable power center addressing the most common needs of power for a consumer. The power center preferable can provide DC power, AC power, battery charging capability, the capability to jumpstart a vehicle with a depleted battery, and other power providing capabilities. The power center includes a housing that is adapted to be used as a toolbox. The housing can include various compartments and the like to house accessories and tools.

### BACKGROUND OF THE INVENTION

Hand tools such as saws, drills, screwdrivers, nail guns, etc. are now often power driven. These tools may be powered by battery or from an electrical outlet. A tool box is typically used to store the hand tools and to transport the tools to remote locations. At the remote locations, the tools battery supply may become depleted or an electrical outlet may not be available. In these circumstances, the power features of the hand tools are rendered useless.

Thus, there is a need for a device that can address the power needs generated by modern power tools and other consumer power requirements.

### SUMMARY OF THE INVENTION

In an exemplary embodiment of the invention, a “tool box” style power center is provided.

The power center may be designed as a versatile, portable power center addressing the most common needs of power for a consumer. The power center preferable can provide DC power, AC power, battery charging capability, the capability to jumpstart a vehicle with a depleted battery, and other power providing capabilities. The power center includes a housing that is adapted to be used as a toolbox. The housing can include various compartments and the like to house accessories and tools.

In another embodiment of the invention, the portable power center, comprises a housing; an AC outlet provided on the housing; a DC outlet provided on the housing; a battery disposed with the housing and coupled to the DC outlet; a power inverter disposed in the housing and receiving DC input from the battery and providing AC output to the AC outlet; a battery charger disposed in the housing, the battery charger coupled to the AC input and providing charging current to the battery; and an air compressor disposed with in the housing and coupled to the battery.

In another embodiment of the invention, the portable power center, comprises a housing; an AC outlet provided on the housing; a DC outlet provided on the housing; an AC input provided on the housing; a battery disposed with the housing and coupled to the DC outlet; a power inverter disposed in the housing and receiving DC input from the battery and providing AC output to the AC outlet; a battery charger disposed in the housing, the battery charger coupled to the AC input and providing charging current to the battery;
jumper cables having one end coupled to at least one of the battery and the battery charger and receiving charging current therefrom and a second end including battery clamps for attachment to an external battery;
and an air compressor disposed with in the housing and coupled to the battery.

### BRIEF DESCRIPTION OF THE DRAWINGS

FIG. 1 is a perspective view of an exemplary embodiment of a portable power center according to the invention; and

FIG. 2 is a block diagram illustrating the components of the portable power center according to an exemplary embodiment of the invention.

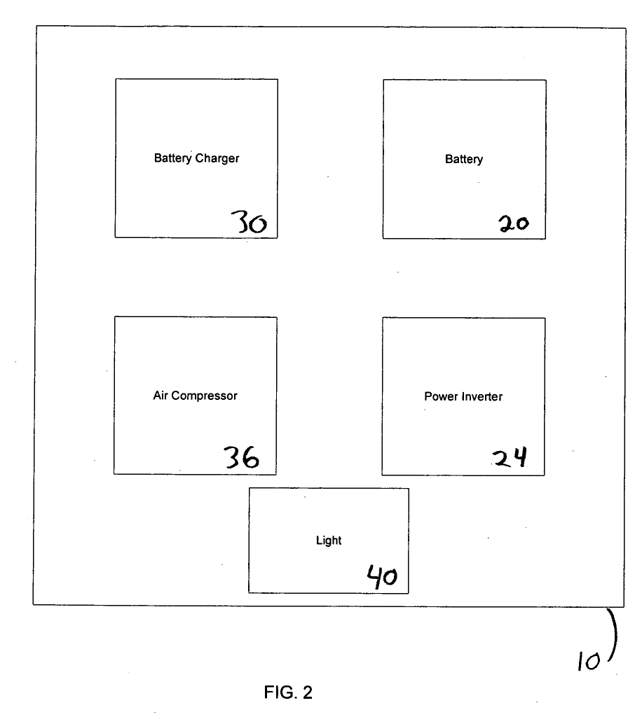

### DETAILED DESCRIPTION OF A PREFERRED EMBODIMENT

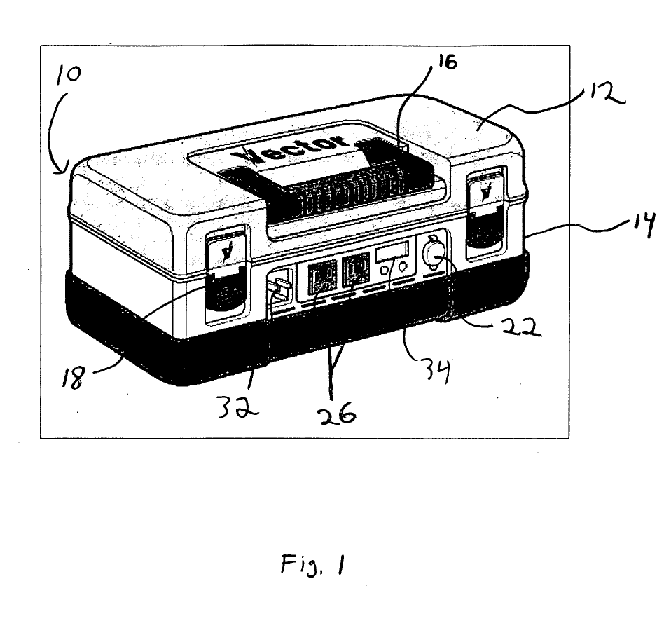

The portable power center shown in FIG. 1 includes a housing 10. In the embodiment illustrated, the housing takes to form of a tool box having a lid 12 and a base 14. The lid 12 may be opened or closed to expose or enclosed a cavity within the housing 10. The cavity may be used to store tools or other items. The lid 12 may be provided with a handle 16 that may be used to carry the power center. Latches 18 or other securing devices may be provided on the lid 12 to secure the lid 12 in the closed position on the base 14.

Compartments, drawers, and the like can be provided on and within the housing 10 to provide storage for accessories and tools. The housing 10 includes an easy to grasp handle 16 that allows the power center to be moved about. Additionally, wheels and/or a large carrying strap can be provided for easy of portability and transporting the power center.

A power source 20, for example a battery, such as a sealed lead acid battery, a nickel cadmium battery, a nickel metal hydride battery or the like, may be disposed in the housing 10. The battery 20 is adapted to provide DC power for a variety of applications. One or more outlets 22 into which various devices can be plugged may be provided on housing 10. The outlet 22 may be similar to a cigarette lighter outlet in a car. For example, a charger for mobile phone or other device can be plugged into the outlet 22 for charging. Additionally, the battery 20 can provide power for a microprocessor or other circuitry that is used to control the operation of the various components described below that may be provided in the power center. For example, the battery 20 can also provide power to operate a compressor or a light, as described below, that may be included in the power center.

The battery 20 may provide a portable power source that can be used to operate various devices when other power sources are not available. For example, the DC power from the battery 20 can be converted into AC power in order to provide a supply of AC power. This feature is very useful to consumers where an AC outlet is in accessible or inconvenient. Consequently, the power center should include a power inverter 24 such as that described in U.S. patent Ser. No. 10/214,340 which is incorporated herein by reference. The power inverter 24 should be housed within the housing 10 for the power center. Receptacles 26 that are adapted to receive a typical AC plug are provided on the housing 10 and coupled to the power inverter 24 in order to provide AC power to a device plugged therein. The power inverter 24 may have the capability to convert DC to AC and AC to DC. When converting AC to DC, an output of the power inverter 24 should be coupled to the DC outlet.

The battery 20 can also be used to provide jumpstarting power for vehicles such as cars, RVs, and the like, which cannot start due to a depleted vehicle battery. The power center therefore may include a set of built in jumper cables that may be used to connect the battery 20 in the power center to the depleted vehicle battery. Such jumper cables are well known to those of ordinary skill in the art and are not illustrated. The lid of the tool box like-housing can be provided with pins, guides, compartments or the like in order to allow a user to wrap the jump starter cables for storage, thus keeping the cables neat and accessible.

The power center can also be provided with a battery charger 30. The battery charger 30 can be adapted to provide charging power for both the battery 20 internal to the power center as well as for external applications. The battery charger 30 may be a high frequency charger, such as the high frequency charger disclosed in U.S. patent application Ser. No. 10/270,391, filed Oct. 15, 2002, which is incorporated herein by reference. The housing 10 of the power center may be provided with a plug 32 that can be coupled to an AC power supply. The battery charger 30 within the power center is coupled to the plug 32 and outputs a DC power signal that can be used to charge an external battery. The output power signal can be provided to the battery 20 internal to the power center for charging thereof. Alternatively, the DC output power signal can be provided to an external battery via the jump starter cables, for example. The battery charger may include many of the features described in U.S. patent application Ser. No. 10/270,391, such as an alternator check function, fault codes, a battery recondition mode, a CCA read out, and others. A battery gauge 34 such as a linear meter for a digital read out or a bar graph can be provided to display to the user the status of the internal and/or the external battery being charged. The gauge or read out should be provided on a front surface of the housing.

A compressor 36 for providing compressed air may also included in the power center. The compressor 36 can be used to inflate tires, mattresses, rafts or other inflatable items. The compressor 36 may be a microprocessor controlled compressor such as that described in U.S. Patent Provisional Application filed Jun. 12, 2003, entitled “Microprocessor Controlled Compressor System.” The compressor 36 may be coupled to gauge 36 to display information such as pressure readings, pressure points, etc. The compressor 36 can normally operate via power supplied from the battery 20 internal to the power center. However, the power center can be adapted such that other DC power sources can operate the compressor 36. For example, the power center may be provided with an input to receive DC power from an external power source when the battery 20 is low or is depleted.

The power center may also provided with a light source 40. The light source 40 may be integral to the housing 10 such as an incandescence lamp, fluorescent lamp, LED or other light source that is formed in the housing. The light source 40 is adapted to receive power from the battery 20 of the power center. Of course, the light source 40 can also be adapted to receive power from an external source in a manner similar to that described above for the compressor. The light source 40 may also include a “light stick” or other type of detachable light device that can be removed from the housing. The detachable light device can be secured in the housing to be charged with power and then removed from the housing to provide a portable light source.

Numerous different options are contemplated within the apparatus electrically, these options may include such schemes as totally enclosing the internal wiring terminating at a single point input/outlet for all charging functions or, conversely, at multiple points both internal and external. The power inverter, battery charger and other devices may be of varying watts, amperage ratings, etc. The battery configuration may include several different types of technology such as nickel cadmium, lead acid, etc. A port may be provided in the power center to allow for the addition of external batteries of greater capacity than the internal battery. Each of the aforementioned devices are contained within the same housing for a portable power center that has a toolbox like appearance. The power center can provide both DC and AC power in addition to jump-starting and battery charging capabilities.

1. A portable power center, comprising:
a housing;
an AC outlet provided on the housing;
a DC outlet provided on the housing;
a battery disposed with the housing and coupled to the DC outlet;
a power inverter disposed in the housing and receiving DC input from the battery and providing AC output to the AC outlet;
a battery charger disposed in the housing, the battery charger coupled to the AC input and providing charging current to the battery; and
an air compressor disposed with in the housing and coupled to the battery.

2. The power center of claim 1, wherein the DC outlet is adapted to receive a cigarette plug adapter.

3. The power center of claim 1, further comprising jumper cables having one end coupled to the battery charger and receiving charging current therefrom and a second end including battery clamps.

4. The power center of claim 1, further comprising jumper cables having one end coupled to the battery and receiving charging current therefrom and a second end including battery clamps.

5. The power center of claim 1, wherein the housing further comprises a compartment to store the jumper cables.

6. The power center of claim 1, further comprising a light disposed on the housing and powered by the battery.

7. The power center of claim 1, wherein the housing further comprising a recess for receiving a light stick.

8. The power center of claim 1, wherein the housing includes a base and a lid hingedly connected to the base, the housing defining a storage cavity therein.

9. The power center of claim 1, wherein the AC input and AC output are one outlet.

10. A portable power center, comprising:
a housing;
an AC outlet provided on the housing;
a DC outlet provided on the housing;
an AC input provided on the housing;
a battery disposed with the housing and coupled to the DC outlet;
a power inverter disposed in the housing and receiving DC input from the battery and providing AC output to the AC outlet;
a battery charger disposed in the housing, the battery charger coupled to the AC input and providing charging current to the battery;
jumper cables having one end coupled to at least one of the battery and the battery charger and receiving charging current therefrom and a second end including battery clamps for attachment to an external battery; and
an air compressor disposed with in the housing and coupled to the battery.
